(19) United States
(12) Patent Application Publication
(10) Pub. No.: US 2022/0115899 A1
(43) Pub. Date: Apr. 14, 2022

(54) Renewable Energy Source Generator and System

(71) Applicant: Wilton Damond Merritt, Washington, DC (US)

(72) Inventor: Wilton Damond Merritt, Washington, DC (US)

(73) Assignee: Merritt IP Holdings, LLC, Birmingham, AL (US)

(21) Appl. No.: 17/450,937

(22) Filed: Oct. 14, 2021

Related U.S. Application Data
(60) Provisional application No. 63/091,397, filed on Oct. 14, 2020.

(51) Int. Cl. H02J 7/35; H02S 20/30; H02S 40/36

(52) U.S. Cl. CPC H02J 7/35; H02S 40/36; H02S 20/30

(57) ABSTRACT

A renewable energy source generator comprising a base, a power module, a marine switch panel, and an electric output device. A renewable energy source generator system.

### CROSS REFERENCE TO RELATED APPLICATION

This application claims the benefit of U.S. Provisional Application No. 63/091,397 filed on Oct. 14, 2020. The above identified patent application is herein incorporated by reference in its entirety to provide continuity of disclosure.

### BACKGROUND

Electricity generation, transmission, and distribution are essential to daily life and commerce in America. By way of background, the U.S. power grid is a network of power plants and infrastructure that supplies energy to power everything from industry to homes. Extreme weather events and cyberattacks, among other threats, pose a threat to the stability of the U.S. electric grid. As a case in point, Texas experienced wide-spread power failures during the winter months of 2021. The state experienced record-breaking low temperatures and multiple power generation sources failed as demand for heat energy surged. The result was widespread outages during a severe winter storm which left millions without power and even lead to dozens of deaths. The power grid's increasing reliance on digital systems also increases vulnerability to cyberattacks—a ransomware attack in May 2021 temporarily shut down one of America's largest pipelines.

Gas-powered generators are a known solution to the problem of generating power without the electric grid. A significant disadvantage of gas-powered generators is that they produce toxic exhaust and are not well-suited to indoor applications. As a case in point, the Louisiana Department of Health reported that 8 of the 15 deaths related to Hurricane Laura—which made landfall in 2020—were due to carbon monoxide asphyxiation caused by the improper use of portable generators. Furthermore, gas-powered generators rely on gas which may also become inaccessible in an emergency or severe weather event.

The state of the art further includes solutions that convert renewable sources like wind and water to electricity. For example, wind and water turbines use natural sources to capture mechanical energy and convert it to electricity. Advantages of these systems are renewable “fuel” source and no toxic exhaust. Disadvantages, as applied to this field of endeavor, are cost and lack of portability, among others. In fact, wind and water turbines are well-suited to be meshed into the electric grid and accounted for about 20% of US electric generation in 2020.

The state of the art includes a range of solar generator solutions that do not solve problems related to the field of endeavor mentioned herein. For example, the state of the art does not contemplate a system configured to scale maximum power output. The state of the art does not disclose a generator configured to be mechanically interlocked with another generator. The state of the art does not disclose a generator optimized for disaster response.

The machine and system disclosed herein advance the state of the art by overcoming disadvantages inherent to the field of endeavor, and conferring other advantages as disclosed herein.

“Busbar” as used herein refers to a metallic strip or bar for facilitating high current power distribution.

“Crate” as used herein refers to milk crates—cube or cuboid containers commonly used to transport milk and other goods that have two holes for holding the crate and configured to interlock when stacked vertically. Milk crates are commonly made of hard plastic and have 4 vertical sides and a bottom but do not have a lid.

“Electric energy storage” as used herein refers to any device for the storage of electricity that can be discharged and recharged.

“Marine switch panel” as used herein refers to a water-resistant panel for controlling an electric system.

“Solar panel” as used herein refers to a photovoltaic solar panel. “Solar panel” and “photovoltaic solar panel” may be used interchangeably.

### BRIEF SUMMARY OF THE DISCLOSURE

A renewable energy source generator and system is described herein.

An object of this disclosure to provide a novel renewable energy source generator and system.

Another object of this disclosure is to provide a renewable energy source generator suited for emergency response situations

A further object of this disclosure is to provide a scalable system for generating electric power from renewable energy that functions independent from the power grid.

The objects of this disclosure are satisfied by A renewable energy source generator comprising: a base; a power module, the power module having an at least first solar panel and an at least second solar panel mechanically coupled to the base, an at least first charge controller, an at least first electric energy storage, the at least first charge controller electrically coupled to the at least first solar panel, the at least second solar panel, and the at least first electric energy storage; and a marine switch panel configured to supply direct current power, electrically coupled to the power module and mechanically coupled to the base.

The foregoing and still other objects are satisfied by a renewable energy source generator comprising: a base, wherein the base is a crate substantially cuboid in shape having four vertical sides, one horizontal bottom side configured to be interlocked with another crate, and an open top the base having a lid mechanically coupled to the open side, and a divider panel substantially the width and height of the base mechanically coupled to the inside of the base, and a first and a second solar panel lift mechanically coupled to two sides of the base and configured to be mechanically coupled to the underside of an at least first and an at least second solar panel; a power module, wherein the power module having a first solar panel, a second solar panel, a charge controller, an alternating current adapter, an electric energy storage, the charge controller electrically coupled to the first solar panel, the second solar panel, and the electric energy storage, and the alternating current adapter electrically coupled to the electric energy storage; the power module mechanically coupled to the base; a marine switch panel electrically coupled to the power module and mechanically coupled to the base; and an at least first electric output device electrically coupled to the marine switch panel and mechanically coupled to the base.

The foregoing and still other objects are satisfied by A renewable energy source generator system comprising: an at least first renewable energy source generator and an at least second renewable energy source generator according to claim 1; wherein the at least first renewable energy source generator mechanically coupled to the at least second renewable energy source generator by vertically stacking the at least first renewable energy source generator base on the at least second renewable energy source generator base; and the at least first renewable energy source generator electrically coupled to the at least second renewable energy source generator.

### BRIEF DESCRIPTION OF THE SEVERAL VIEWS OF THE DRAWINGS

Implementations of a renewable energy source generator and system are illustrated in FIGS. 1-10.

FIG. 1-1 shows a perspective view of an implementation of a renewable energy source generator;

FIG. 1-2 shows a perspective view of another implementation of a renewable energy source generator;

FIG. 2-1 shows a front view of an implementation of a renewable energy source generator;

FIG. 2-2 shows a front view of another implementation of a renewable energy source generator;

right-side cross section view thereof;

FIG. 3-1 shows a rear view of an implementation of a renewable energy source generator;

FIG. 3-2 shows a rear view of another implementation of a renewable energy source generator;

FIG. 4 shows a perspective view of another implementation of a renewable energy source generator;

FIG. 5-1 shows a top view of an implementation of a renewable energy source generator;

FIG. 5-2 shows a top view of another implementation of a renewable energy source generator;

FIG. 6-1 shows a side view of an implementation of a renewable energy source generator;

FIG. 6-2 shows a side view of another implementation of a renewable energy source generator;

FIG. 7-1 shows a front view of another implementation of a renewable energy source generator;

FIG. 7-2 shows a front view of another implementation of a renewable energy source generator;

FIG. 8 shows a cross-section view of a renewable energy source generator;

FIG. 9 shows a top view of an implementation of a renewable energy source generator.

FIG. 10 shows an implementation of a renewable energy source generator system.

### DETAILED DESCRIPTION

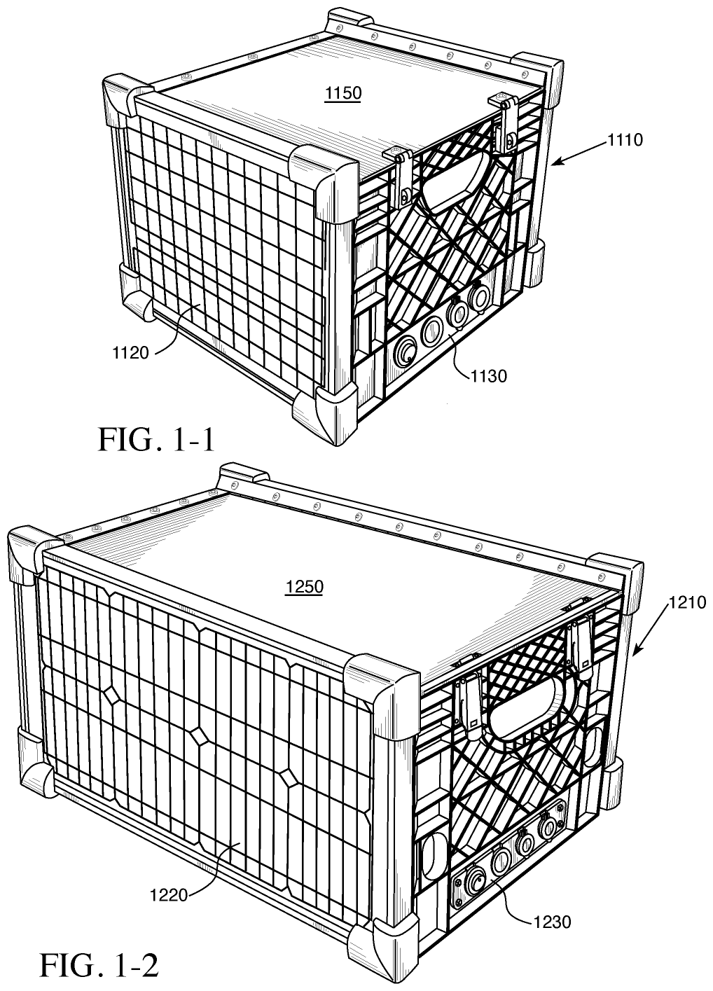

FIG. 1-1 shows an implementation of a renewable energy source generator. In implementations, as shown in FIG. 1-1, a renewable energy source generator base 1110 may be a crate. In implementations, a renewable energy source generator base is a cube with 5 closed sides and the top side open. In implementations, a renewable energy source generator may comprise a base 1110, a power module, a marine switch panel 1130, and an electric output device, wherein the power module comprises at least a first solar panel 1120, and at least a first electric energy storage, the at least first solar panel 1120 electrically coupled to the at least first electric energy storage; wherein the marine switch panel 1130 electrically coupled to the power module and the electric output device; and wherein the power module, the marine switch panel 1130; and the electric output device mechanically coupled to the base 1110. In implementations of a renewable energy source generator 1100, a power module is housed inside the base: the advantages of which, as explained herein, will be apparent to a skilled artisan. In embodiments of a renewable energy source generator 1110, marine switch panel 1130 is disposed on a front face of the base 1110.

In implementations a renewable energy source generator base 1110 has two handles on opposite sides, as is common to crates.

In implementations, a renewable energy source generator base 1110 may further comprise a lid 1150 mechanically coupled to the base. In implementations, a renewable energy source generator lid 1150 is mechanically coupled to the base using a hinge. In implementations of a renewable energy source generator 1100, a hinge is a piano-type hinge. In implementations of a renewable energy source generator 1100, a base may further comprise a latch for securing lid 1150 to the base 1110 opposite the hinge. In embodiments a latch is a briefcase-style latch. An advantage of this implementation is enhancing the durability and water resistance of an energy source generator 1100. In implementations, a lid 1150 may further comprise a handle mechanically coupled to the lid 1150.

In implementations a renewable energy source generator base 1110 may further comprise a handle mechanically coupled to the base. In implementations of a renewable energy source generator base 1110 a handle may be a telescoping handle. In implementations, a renewable energy source generator base 1110 may further comprise at least a first and at least a second wheel mechanically coupled to the base.

In implementations, a renewable energy source generator base 1110 is optimized to enhance water resistance. In implementations, a renewable energy source generator base further comprises a liner mechanically coupled to the inside of the base. In implementations, a renewable energy source generator liner has sufficient tensile strength to support the weight of an alternating charge adapter and common tools for emergency response.

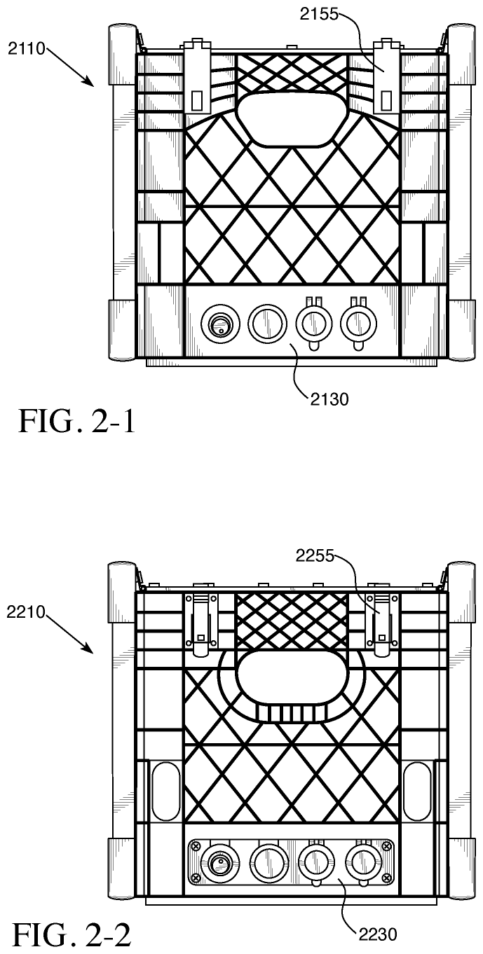

FIG. 1-2 shows an implementation of a renewable energy source generator. In implementations, as shown in FIG. 1-2, a renewable energy source generator base 1210 may be a cuboid having five closed sides and the top side open. In implementations a renewable energy source generator base 1210 has two handles on opposite sides, as is common to crates.

In implementations, a renewable energy source generator base 1210 may further comprise a lid 1250 mechanically coupled to the base. An advantage of this implementation is enhancing the water resistance of the durability and water resistance of a renewable energy source generator.

Marine switch panel. FIG. 2-1 shows a front view of an implementation of a renewable energy source generator. In implementations, a renewable energy source generator marine switch panel 2130 is configured to supply direct current power and is electrically coupled to the at least first electrical output device. In implementations, a marine switch panel 2130 may be a water-resistant accessory panel. In implementations, a marine switch panel 2130 may be a water-resistant instrument panel.

In implementations, a marine switch panel 2130 is mechanically coupled to a renewable energy source generator base 2110. In implementations of a renewable energy source generator, a base may further comprise a latch 2155 for securing lid to the base 2110 opposite the hinge. In embodiments a latch is a briefcase-style latch.

FIG. 2-2 shows a front view of an implementation of a renewable energy source generator. In embodiments a latch 2255 may be mechanically coupled to the base. In embodiments a latch 2255 is a briefcase-style latch.

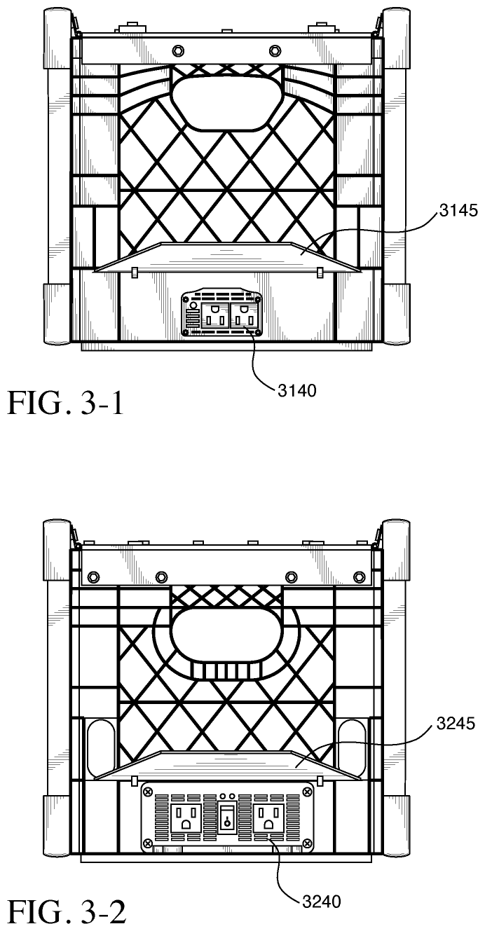

In implementations of a renewable energy source generator, as shown in FIG. 3-1, a renewable energy source generator electric output device 3140 is disposed on a base opposite a marine switch panel. In implementations a renewable energy source generator base further comprises a shield 3145 mechanically coupled to the base and configured to be displaced for access to the electric output device 3140. In implementations, a electric output device 3140 is configured to deliver alternating current power.

In implementations, an electric output device is car stereo receiver having a speaker electrically coupled to it. In implementations, an electric output device is a bluetooth receiver having a speaker electrically coupled to it. In implementations, the speaker may be mechanically coupled to the base.

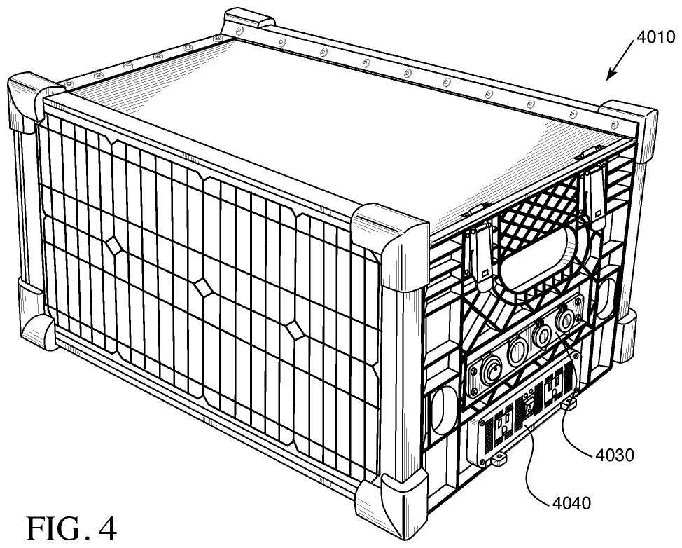

In implementations of a renewable energy source generator, as shown in FIG. 4, a renewable energy source generator electric output device 4040 is disposed on the same face of a base 4010 as a marine switch panel 4030. In implementations, a renewable energy source generator may comprise additional electric output devices electrically coupled to the power module and the marine switch panel 4030.

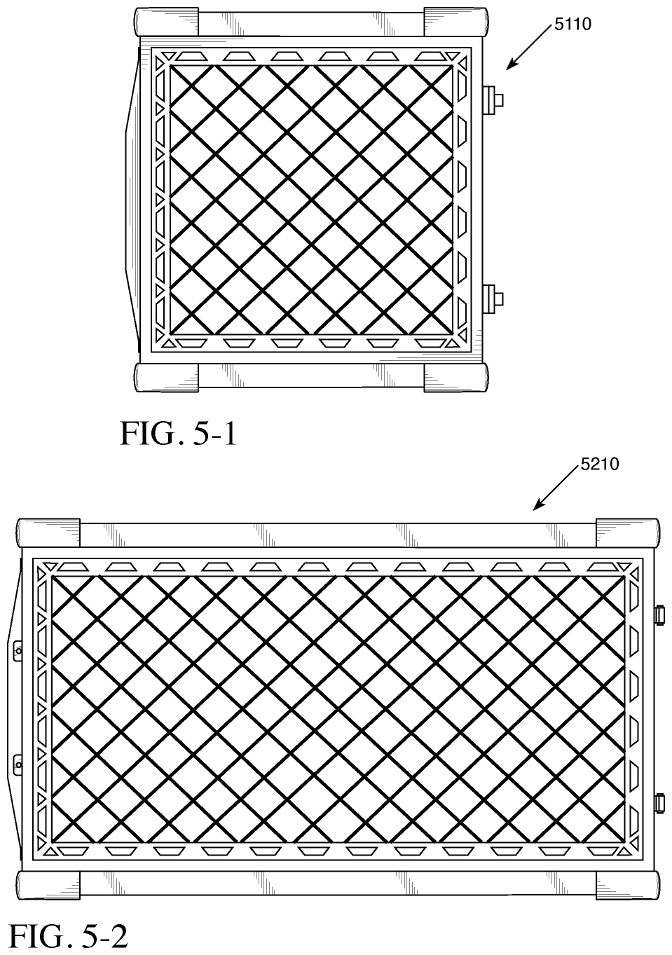

FIGS. 5-1 and 5-2 show a bottom view of an implementation of a renewable energy source generator. In implementations, a renewable energy source generator base 5110 and 5210 is a crate configured to be mechanically coupled with other crates in a vertical stack, as is common to crates.

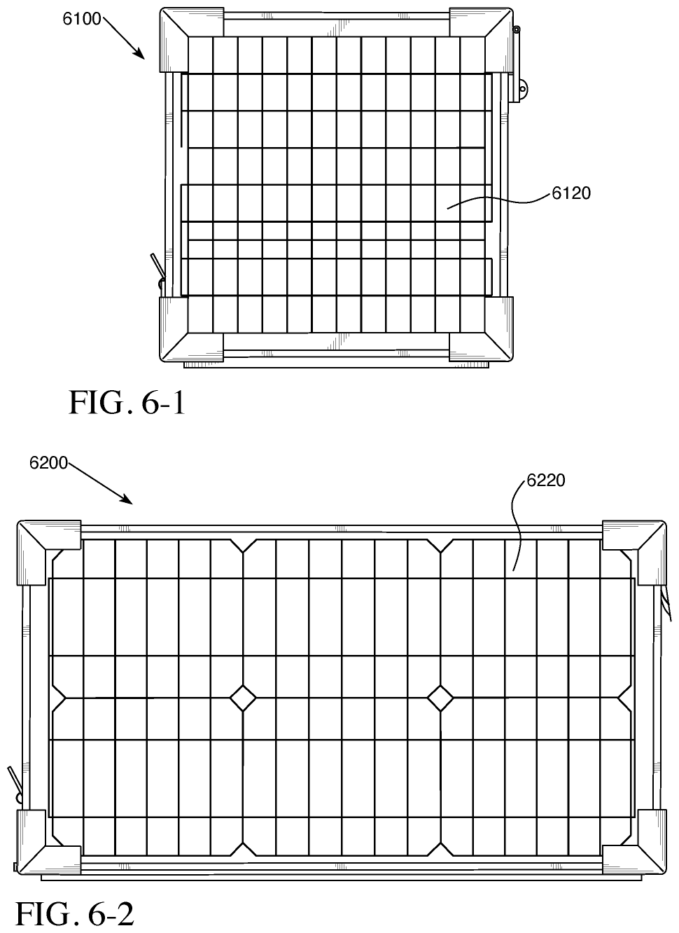

FIG. 6-1 shows a side view of an implementation of a renewable energy source generator 6100. In implementations, a solar panel 6120 is approximately the size and surface area of a vertical side of the base. In implementations of a renewable energy source generator 6100, an at least first solar panel 6120 may be a 15-Watt photovoltaic solar panel. In implementations of a renewable energy source generator 6100, a solar panel may be approximately 13 inches wide by 11 inches tall. In implementations of a renewable energy source generator power module, a solar panel 6120 may be approximately 14.5 inches wide by 15 inches tall. In implementations, an at least first solar panel 6120 may be fitted with bumpers to enhance durability of the solar panels and absorb impact to the corners of the panels.

FTC. 6-2 shows a side view of an implementation of a renewable energy source generator 6200. In implementations of a renewable energy source generator power module, a solar panel 6220 may be approximately 19 inches wide by 11 inches tall. In implementations, an at least first solar panel 6220 may be fitted with bumpers to enhance durability of the solar panels and absorb impact to the corners of the panels.

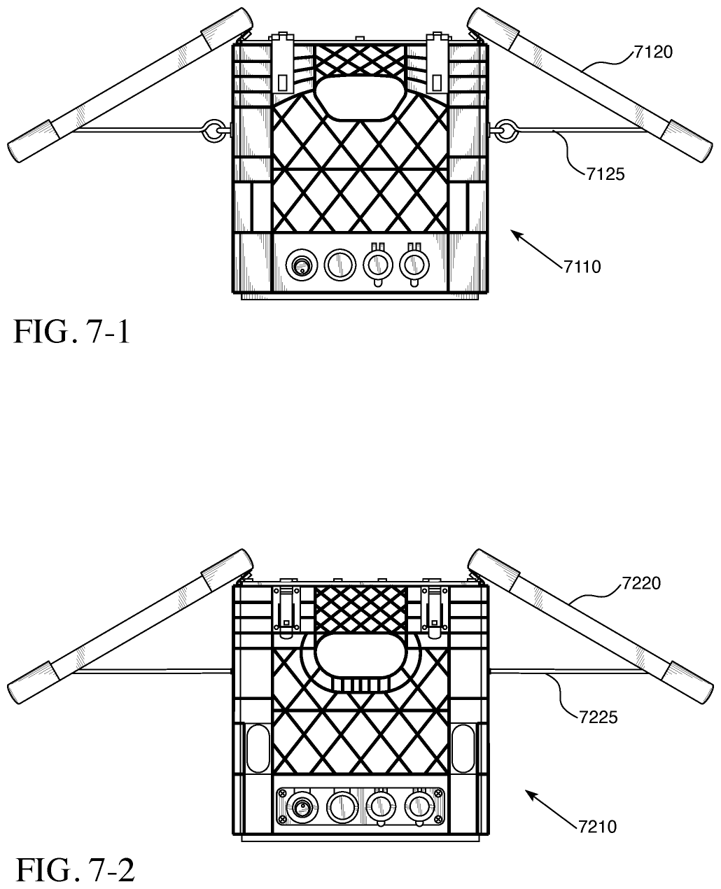

In implementations, as shown in FIGS. 7-1 and 7-2, a renewable energy source generator base 7110 and 7210 further comprises a solar panel lift 7125 and 7225 to elevate an at least first solar panel 7120 and 7220. An advantage of this implementation is that the at least first solar panel 7120 and 7220 can be configured by a user to optimize exposure to the sun, and by extension, decrease time to recharge the electric energy storage. In implementations, a solar panel lift 7125 is an eyebar. In implantations, a solar panel lift 7225 is a ¼″ aluminum rod.

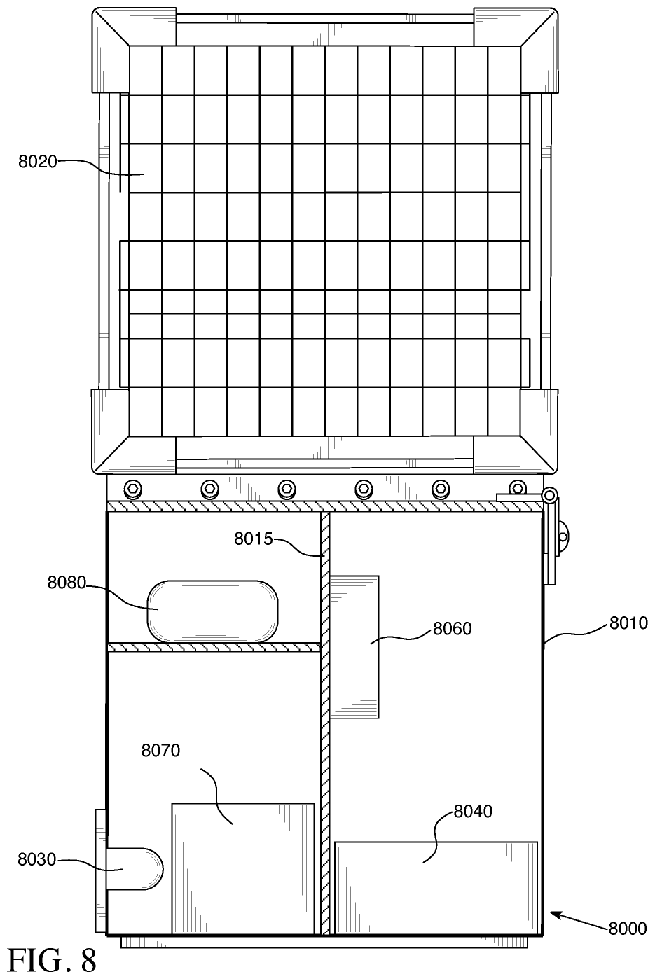

Power module. FIG. 8 shows an implementation of a renewable energy source generator power module. In implementations, a renewable energy source generator power module 8000 may comprise an at least first solar panel 8020, an at least first charge controller 8060, and an at least a first electric energy storage 8070. In implementations of a renewable energy source generator power module 8000, an at least first solar panel 8020 may be electrically coupled to an at least first charge controller 8060, and the at least first charge controller 8060 may be electrically coupled to an at least first electric energy storage 8070.

In implementations of a renewable energy source generator, a power module 8000 may further comprise an at least second solar panel, the at least first solar panel 8020 and at least second solar panel mechanically coupled to the open side of the base 8010. In implementations of a renewable energy source generator power module 8000, each of an at least first solar panel 8020 and an at least second solar panel may be mechanically coupled to opposite edges of the open side of the base with a piano hinge.

In implementations, a renewable energy source generator power module 8000 may further comprise a third solar panel and a fourth solar panel, wherein third solar panel and the fourth solar panels electrically coupled to the at least first charge controller 8060, and the third solar panel and the fourth solar panel mechanically coupled to an open side of the base 8010. In implementations the third solar panel and the fourth solar panel mechanically coupled to an open side of the base 8010 using a piano hinge.

In implementations, a renewable energy source generator power module 8000 further comprises an A/C adapter 8080 electrically coupled to at least first electric energy storage 8070. An advantage of this implementation is the versatility to charge the at least first electric energy storage 8070 with traditional electric power in low light conditions. In implementations, an A/C adapter 8080 may be fitted with a retractable cord.

In implementations of a renewable energy source generator power module 8000, an at least first electric energy storage 8070 may be a rechargeable battery. In implementations of a renewable energy source generator power module 8000, an at least first electric energy storage 8070 may be a lead acid battery having a voltage output of 12-volts DC and a capacity of 22-amp hour. In implementations of a renewable energy source generator power module 8000, an at least first electric energy storage 8070 may be a lead acid battery having a voltage output of 24 volts. In implementations of a renewable energy source generator power module 8000, an at least first electric energy storage 8070 may be a capacitor.

In implementations of a renewable energy source generator may further comprise an electrical connector coupled to the at least first electric energy storage 8070.

In implementations, a renewable energy source generator power module 8000 may further comprise an at least second charge controller electrically coupled to an at least first electric energy storage 8070.

In implementations of a renewable energy source generator power module 8000, an at least first charge controller 8060 may be a solar charge controller.

In implementations of a renewable energy source generator, an at least first electrical output device 8040 may be an electrical connector. In implementations, an at least first electrical output device 8040 may be a 12 Volt socket. In implementations, an at least first electrical output device 8040 may be a voltage regulator. In implementations, an at least first electrical output device 8040 may be a digital panel meter. In implementations, an at least first electrical output device 8040 may be an analog panel meter. In implementations, an at least first electrical output device 8040 may be a waterproof digital voltmeter. In implementations, an at least first electrical output device 8040 may be a power inverter. In implementations, an at least first electrical output device 8040 may be a 300-watt sine inverter having two AC 110-Watt outlets and two USB ports.

In implementations, a renewable energy source generator may have an external load electrically coupled to an at least first electrical output device 8040 like a household appliance or a medical device. In implementations, a renewable energy source generator at least first electrical output device 8040 may supply power at the rate of 0.3 kWh. In implementations, a renewable energy source generator at least first electrical output device 8040 may supply power at the rate of 0.7 kWh. In implementations, a renewable energy source generator at least first electrical output device 8040 may supply power at the rate of 2 kWh.

In implementations, a renewable energy source generator base 8010 is optimized to enhance physical storage capacity. In implementations, a renewable energy source generator base 8010 further comprises a divider panel 8015 configured to bisect the renewable energy source generator base 8010. In implementations, a renewable energy source generator base 8010 is configured such that a divider panel 8015 may be mechanically coupled to the base. In implementations, a charge controller 8060 may be mechanically coupled to a divider panel 8015. In implementations, an alternating current adapter 8080 may be mechanically coupled to a divider panel 8015. In implementations, and alternating current adapter 8080 is configured to meter energy delivered to the at least first electric energy storage 8070 thereby optimizing the health and maximum cycles of the at least first electric energy storage 8070.

In implementations, a marine switch panel 8030 may be electrically coupled to the power module 8000 and mechanically coupled to the base 8010.

In implementations, a pole fitted with a light may be mechanically coupled to the base and the light may be electrically coupled to the power module. In implementations, a light pole may be mechanically coupled to the base and electrically coupled to the electric output device. An advantage is that heavy items may be stored inside the base to counter-balance the torque of the pole assembly.

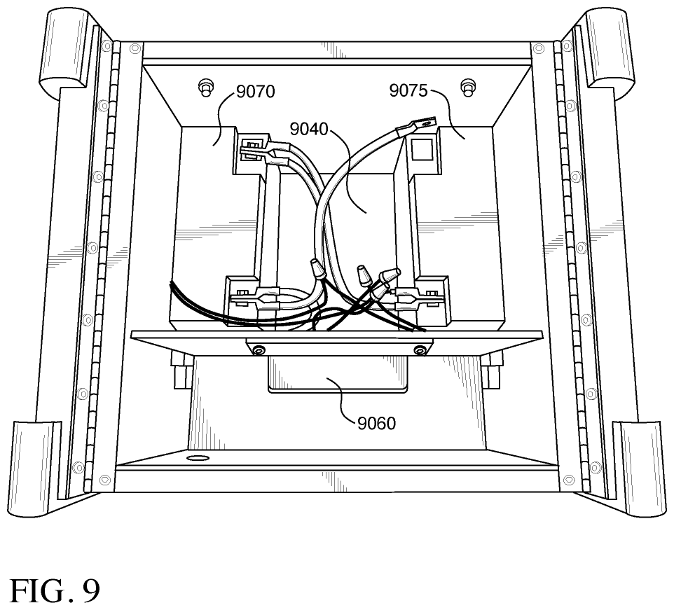

FIG. 9 shows an implementation of a renewable energy source generator power module. In implementations, a renewable energy source generator power module may comprise: an at least first solar panel and an at least second solar panel, an at least first charge controller 9060, an at least first energy storage 9070 and an at least second electric energy storage 9075, wherein the at least first charge controller 9060 electrically coupled to the at least first solar panel, the at least second solar panel, the at least first electric energy storage 9070, and the at least second energy storage 9075; the power module mechanically coupled to the base; the electric output device 9040 electrically coupled to the power module and mechanically coupled to the base.

In implementations of a renewable energy source generator power module 9000, an at least second electric energy storage 9075 electrically coupled to an at least first electric energy storage 9070. In implementations, a renewable energy source generator may further comprise a marine switch panel electrically coupled to the at least first electric energy storage or the at least second electric energy storage and mechanically coupled to the base.

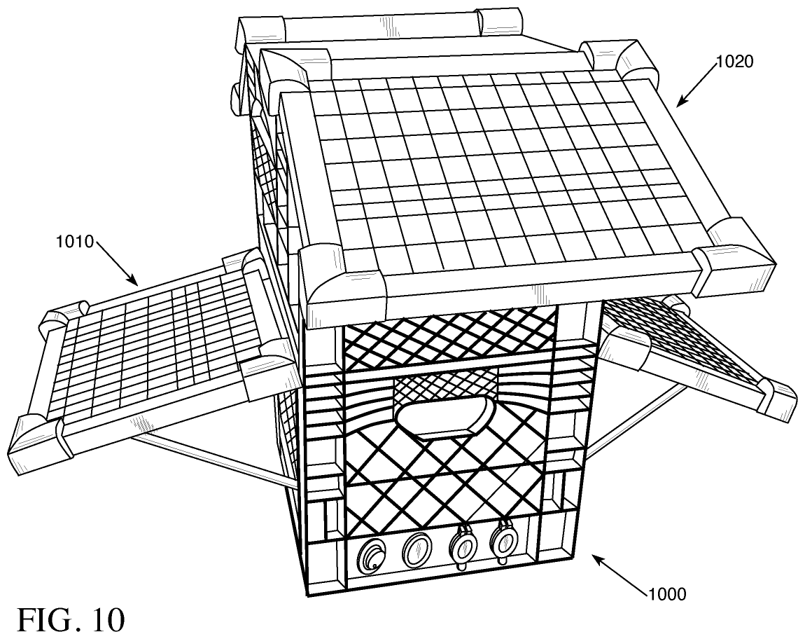

Renewable energy source generator system. FIG. 10 shows an implementation of a renewable energy source generator system. In implementations, a renewable energy source generator system may comprise: an at least first renewable energy source generator 1010, an at least second renewable energy source generator 1020; wherein the at least first renewable energy source generator 1010 and the second renewable energy source generator 1020 are mechanically coupled by stacking the at least first renewable energy source generator vertically on the at least second renewable energy source generator 1020; and the at least first renewable energy source generator 1010 electrically coupled to the at least second renewable energy source generator 1020. In implementations of a renewable energy source generator system 1000, and as described herein (e.g. paragraph [051]), the base of an at least first renewable energy source generator 1010 and the base of an at least second renewable energy source generator 1020 may be adapted to be stacked vertically on one another. An advantage, as shown in FIG. 10, is that a renewable energy source generator system 1000 may be positioned such that the panels of the renewable energy source generator in the bottom position of the stack do not obstruct the panels of the renewable energy source generator at the top of the stack. In implementations, a renewable energy source generator system further comprises additional renewable energy source generators stacked in the configuration shown.

In implementations of a renewable energy source generator system 1000, an at least second renewable energy source generator 1020 may be electrically coupled in series with an at least first renewable energy source generator 1010. In implementations of a renewable energy source generator system 1000, an at least first renewable energy source generator 1010 as described herein may be electrically coupled to an at least second renewable energy source generator 1020 by electrically coupling an at least first energy storage of the at least first renewable energy source generator 1010 to an at least first energy storage of the at least second renewable energy source generator 1020.

In implementations of a renewable energy source generator system 1000, an at least second renewable energy source generator 1020 may be electrically coupled in parallel with an at least first renewable energy source generator 1010. In implementations, a renewable energy source generator system 1000 further comprises a busbar, and the at least first energy storage of the at least first renewable energy source generator 1010 and the at least first energy storage of the at least second renewable energy source generator 1020 electrically coupled to the busbar.

The implementations of a renewable energy source generator and systems described herein may not capture all the various modifications that are possible. Accordingly, it is understood that the scope of the disclosure should be determined in reference to the claims below. In sum, it is understood that the scope of the disclosure is not necessarily limited to the implementations discussed above.

I claim:

1. A renewable energy source generator comprising:
a base;
a power module,
the power module having an at least first solar panel and an at least second solar panel mechanically coupled to the base, an at least first charge controller, an at least first electric energy storage, the at least first charge controller electrically coupled to the at least first solar panel, the at least second solar panel, and the at least first electric energy storage; and
a marine switch panel configured to supply direct current power, electrically coupled to the power module and mechanically coupled to the base.

2. The renewable energy source generator according to claim 1 wherein the base is a crate substantially cuboid in shape having four vertical sides, one horizontal bottom side configured to be interlocked with another crate, and an open top.

3. The renewable energy source generator according to claim 2,
wherein the at least first solar panel mechanically coupled to the top of the base opposite the at least second solar panel; and
the power module mechanically coupled to the base.

4. The renewable energy source generator according to claim 3, further comprising:
an at least first electric output device electrically coupled to the marine switch panel and the power module.

5. The renewable energy source generator according to claim 4 wherein the at least first electric output device is a plurality of electric output devices.

6. The renewable energy source generator according to claim 4 wherein the at least first electric output device is an alternating current inverter.

7. The renewable energy source generator according to claim 3, further comprising:
a divider panel,
wherein the charge controller mechanically coupled to the divider panel, the divider panel mechanically coupled to the base; and
the power module mechanically coupled to the base.

8. The renewable energy source generator according to claim 3, further comprising an alternating current adapter configured to preserve the at least first electric energy storage, the alternating current adapter electrically coupled to the at least first electric energy storage and mechanically coupled to the base.

9. The renewable energy source generator according to claim 4 further comprising a first solar panel lift and a second solar panel lift mechanically coupled to the base and adapted to be mechanically coupled to the underside of the at least first solar panel and the at least second solar panel.

10. The renewable energy source generator according to claim 3 further comprising a pole fitted with a light, wherein the pole mechanically coupled to the base and the light electrically coupled to the power module.

11. The renewable energy source generator according to claim 4 further comprising a speaker, wherein the electric output device is a bluetooth receiver and wherein the speaker electrically coupled to the electric output device.

12. The renewable energy source generator according to claim 3, the power module further comprising:
an at least second electric energy storage electrically coupled to the at least first energy storage.

13. The renewable energy source generator according to claim 4, the base further comprising a lid mechanically coupled to the base.

14. The renewable energy source generator according to claim 3, further comprising:
an at least first wheel,
an at least second wheel, and
the at least first wheel and at least second wheel mechanically coupled to the base.

15. The renewable energy source generator according to claim 4, further comprising a movable shield disposed over the electric output device and mechanically coupled to the base.

16. The renewable energy source generator according to claim 3, the power module further comprising:
an at least third solar panel,
an at least fourth solar panel,
the at least third solar panel and at least fourth solar panel electrically coupled to the charge controller and mechanically coupled perpendicular to the at least first solar panel and at least second solar panel.

17. A renewable energy source generator comprising:
a base,
wherein the base is a crate substantially cuboid in shape having four vertical sides, one horizontal bottom side configured to be interlocked with another crate, and an open top
the base having
a lid mechanically coupled to the open side, and
a divider panel substantially the width and height of the base mechanically coupled to the inside of the base, and
a first and a second solar panel lift mechanically coupled to two sides of the base and configured to be mechanically coupled to the underside of an at least first and an at least second solar panel;
a power module,
wherein the power module having a first solar panel, a second solar panel, a charge controller, an alternating current adapter, an electric energy storage,
the charge controller electrically coupled to the first solar panel, the second solar panel, and the electric energy storage, and
the alternating current adapter electrically coupled to the electric energy storage;
the power module mechanically coupled to the base;
a marine switch panel electrically coupled to the power module and mechanically coupled to the base; and
an at least first electric output device electrically coupled to the marine switch panel and mechanically coupled to the base.

18. A renewable energy source generator system comprising:
an at least first renewable energy source generator and an at least second renewable energy source generator according to claim 1;
wherein the at least first renewable energy source generator mechanically coupled to the at least second renewable energy source generator by vertically stacking the at least first renewable energy source generator base on the at least second renewable energy source generator base; and
the at least first renewable energy source generator electrically coupled to the at least second renewable energy source generator.

19. The renewable energy source generator system according to claim 18, wherein an at least first energy storage of the at least first renewable energy source generator is electrically coupled to an at least first energy storage of the at least second renewable energy source generator.

20. The renewable energy source generator according to claim 18, further comprising:
a busbar;
wherein the at least first renewable energy source generator and the at least second renewable energy source generator electrically coupled to the busbar.
